(19) United States
(12) Patent Application Publication
(10) Pub. No.: US 2012/0128648 A1
(43) Pub. Date: May 24, 2012

(54) Novel Biopesticide Compositions And Method For Isolation And Characterization Of Same

(75) Inventor: Nutan Kaushik, New Delhi (IN)

(73) Assignee: THE ENERGY AND RESOURCES INSTITUTE (TERI), New Delhi (IN)

(21) Appl. No.: 13/387,697

(22) PCT Filed: Jul. 28, 2009
(86) PCT No.: PCT/IN09/00429

§ 371 Date: Jan. 27, 2012

(51) Int. Cl. A01N 65/28; A01N 63/04; A01N 59/00; A01P 1/00; A01N 59/20; A01P 7/04; A01P 5/00; A01P 3/00; A01N 63/00; A01N 59/26

(52) U.S. Cl. 424/93.461; 424/742; 424/93.6; 424/93.47; 424/93.5; 424/715; 424/601; 424/633; 424/632; 424/637; 424/604

(57) ABSTRACT

The present invention describes the isolation and characterization of the novel biopesticide compositions and/or biopesticide formulations obtained from Eucalyptus species capable of serving as effective biocontrol agents and/or pest control management agents. The invention focuses on the isolation of these biopesticide compositions and formulations that are known to possess pesticidal properties and are derived from natural sources having biological origin. The invention more particularly describes the isolation and characterization, including but not confined to, novel biopesticide compositions possessing pesticidal attributes along with other pharmaceutically important attributes so as to also function as effective biocontrol agents.

### FIELD OF INVENTION

This invention relates generally to the field of compositions and methods for controlling of pests and pest populations which are known to be having a detrimental effect on human life and human activities. The invention focuses on the isolation of these biopesticide compositions and formulations that are known to possess pesticidal properties and are derived from natural sources having biological origin. The invention more particularly describes the isolation and characterization, including but not confined to, novel biopesticide compositions possessing pesticidal attributes along with other pharmaceutically important attributes so as to also function as effective biocontrol agents.

### BACKGROUND OF INVENTION

There is a large amount of activity in the general field of biopesticides derived from natural sources and having an essentially biological origin and their possible exploitation in the field of biocontrol. The prior art is flooded with a large number of patented inventions and technical literature on the subject in question.

The genus Eucalyptus of family (Myrtaceae) owing to the presence of pharmacologically important oils and compounds as well as substances which have known pesticidal and biocontrol attributes has attracted interest of scientific community to investigate the nature, working mechanism and chemistry of these compounds. The genus Eucalyptus (Family Myrtaceae) shows a fairly large distribution in several regions of the world, with about 300 species being known. It is a native of Australian region, however the distribution today is fairly broad to several parts of Europe, South Africa, Northern Africa, America and even tropical countries like India. The Eucalyptus tree has its origin in Australia. Eucalyptus leaves and its oil have been traditionally used as Aboriginal cure for a wide range of diseases. Presently the Eucalyptus extracts are extensively used across the globe in pills, liquids, inhalers and ointments as a cure for several ailments that are general in nature.

### FIELD OF INVENTION

This invention relates generally to the field of compositions and methods for controlling of pests and pest populations which are known to be having a detrimental effect on human life and human activities. The invention focuses on the isolation of these biopesticide compositions and formulations that are known to possess pesticidal properties and are derived from natural sources having biological origin. The invention more particularly describes the isolation and characterization, including but not confined to, novel biopesticide compositions possessing pesticidal attributes along with other pharmaceutically important attributes so as to also function as effective biocontrol agents.

### BACKGROUND OF INVENTION

There is a large amount of activity in the general field of biopesticides derived from natural sources and having an essentially biological origin and their possible exploitation in the field of biocontrol. The prior art is flooded with a large number of patented inventions and technical literature on the subject in question.

The genus Eucalyptus of family (Myrtaceae) owing to the presence of pharmacologically important oils and compounds as well as substances which have known pesticidal and biocontrol attributes has attracted interest of scientific community to investigate the nature, working mechanism and chemistry of these compounds. The genus Eucalyptus (Family Myrtaceae) shows a fairly large distribution in several regions of the world, with about 300 species being known. It is a native of Australian region, however the distribution today is fairly broad to several parts of Europe, South Africa, Northern Africa, America and even tropical countries like India. The Eucalyptus tree has its origin in Australia. Eucalyptus leaves and its oil have been traditionally used as Aboriginal cure for a wide range of diseases. Presently the Eucalyptus extracts are extensively used across the globe in pills, liquids, inhalers and ointments as a cure for several ailments that are general in nature.

It is a well known fact today that, plants are subject to attack by a great number of pests. These pests can be, for example, bacteria, fungi, or nematodes. Pesticidal compounds have long been used to increase yields and extend agricultural production capabilities into new areas. They have also been extremely important tools for ameliorating season-to-season differences in yield and quality caused by weather-driven variations in pest pressure.

The aspect of the longstanding global demand for new, effective, environmentally friendly, and safe means to control pests that damage agriculture or serve as disease vectors is not new to the world today. As per one of the recent reports, in US alone the agriculture costs incurred by pests exceed billions of dollars annually in decreased crop yields, reduced crop quality, increased harvesting costs, pesticide application costs, and negative ecological impact. In addition to agriculture pests, many blood-feeding insects and cockroaches are vectors for pathogenic microorganisms that threaten human and animal health, or are annoying at the least. As in the case of agriculture pests, direct and intangible costs incurred by blood-feeding and household pests concern pesticide safety hazards to humans and animals, bioaccumulation and environmental incompatibility, and synthesis and application costs.

It is also common knowledge today that almost all field crops, nursery and horticulture plants, and commercial farming areas are susceptible to attack by one or more pests. The notable examples that could be cited are inclusive of the particularly problematic Coleopteran and Lepidopteran pests. An example of a Lepidopteran pest is the hornworm larva of Manduca sexta, and an example of a Coleopteran pest is the Colorado potato beetle, Leptinotarsa decemlineata. Vegetable and cole crops, lentils, leafy vegetables, melons, peppers, potatoes and related tubers, tomatoes, cucumbers and related vine crops, as well as a variety of spices are sensitive to infestation by one or more pests including loopers, armyworms, moth larvae, budworms, webworms, earworms, leafeaters, borers, cloverworms, melonworms, leafrollers, various caterpillars, fruitworms, hornworms, and pinworms. Likewise, pasture and hay crops such as alfalfa, pasture and forage grasses and silage are often attacked by a variety of pests including armyworms, alfalfa caterpillars, European skipper, a variety of loopers and webworms, as well as yellowstriped armyworms.

The crop pests pertaining to cotton plant have constituted one of the widely studied pest management area. For instance in case of the pest cotton stainer it is well known that medium to large-sized nymphs and adults feed on seeds in developing cotton bolls. The cotton stainer derives its name from its habit of staining cotton an indelible brownish yellow. As per one publication it was one farmer at Hawthorne, Fla., who in 1902 ginned about 1,000 bales of long-staple cotton, of which about 200 bales were classed as stained. D. suturellus punctures and sucks young bolls, preventing them from coming to maturity.

This insect also has been a severe pest of oranges on occasions. In puncturing an orange, a cotton stainer often inserts its beak full length with no visible wound; nevertheless, a single puncture may cause the orange to drop in a few hours from the tree and to decay in one or two days. There are old reports of orange trees well reddened with cotton stainers in which whole crops were lost.

Some other hosts of D. suturellus include tangerines, okra pods, ripe fruit of papaya, pods and blossoms of oleander, seed pods of Jamaica sorrel (Hibiscus sabdariffa), tree hibiscus (H. syriacus), Turk's cap, teaweed (Sida sp.), Caesar's weed or Spanish cocklebur (Urena lobata), Spanish needle (Bidens pilosa), seaside mahoe or portiatree (Thespesia populnea), rose buds and blossoms, eggplant, nightshade, and guava.

The hosts of the other species of Dysdercus are essentially the same as for suturellus. The Division of Plant Industry has one record of royal poinciana being severely damaged by D. andreae. The feeding activities of cotton stainers on cotton produce a stain on the lint which reduces its value. A few authorities have reported the stain comes from excrement of the bugs. However, most have stated that the stain primarily is a result of the bug puncturing the seeds in the developing bolls causing a juice to exude that leaves an indelible stain. Feeding by puncturing flower buds or young cotton bolls usually causes reduction in size, or the fruiting body may abort and drop to the ground.

Fruit (including citrus), nut, and vine crops are susceptible to attack by a variety of pests, including sphinx moth larvae, cutworms, skippers, fireworms, leafrollers, cankerworms, fruitworms, girdlers, webworms, leaffolders, skeletonizers, shuckworms, hornworms, loopers, orangeworms, tortrix, twig borers, casebearers, spanworms, budworms, budmoths, and a variety of caterpillars and armyworms.

Field crops are targets for infestation by insects including armyworm, asian and other corn borers, a variety of moth and caterpillar larvae, bollworms, loopers, rootworms, leaf perforators, cloverworms, headworms, cabbageworms, leafrollers, podworms, cutworms, budworms, hornworms, and the like. Pests also frequently feed upon bedding plants, flowers, ornamentals, vegetables, container stock, forests, fruit, ornamental, shrubs and other nursery stock. Even turf grasses are attacked by a variety of pests including armyworms and sod webworms.

For the past 50 years growers, health official, and the public have depended on chemical pesticides for controlling a variety of pests. However, environmental experts, health officials, and the public have become concerned about the amount of residual chemicals found in food, ground water, and elsewhere in the environment. Regulatory agencies around the world are restricting and/or banning the uses of many synthetic pesticides, particularly those that are persistent in the environment and that enter the food chain. Stringent new restrictions on the use of pesticides and the elimination of some effective pesticides from the market place could limit economical and effective options for controlling costly pests. Some synthetic chemical pesticides poison the soil and underlying aquifers, pollute surface waters as a result of runoff, and destroy non-target life forms. These synthetic chemical pest control agents have the further disadvantage of presenting public safety hazards when they are applied in areas where pets, farm animals, or children may come into contact with them. They can also pose health hazard to the people applying them, especially if the proper application techniques are not followed.

Because crops of commercial interest are often the targets of pests, environmentally sensitive methods for controlling or eradicating pest infestations are desirable in many instances. This is particularly true for farmers, nurserymen, growers, and commercial and residential areas which seek to control pest populations using environmentally friendly compositions.

Thus, a rational inference in this context can be drawn to the effect that the future role of pesticides in agriculture is increasingly threatened by several factors including; the development of resistant pests, increasing concerns about food safety, and environmental accumulation of toxic compounds. As older pesticides are removed from the market due to regulatory changes, and new pesticides are becoming increasingly expensive to register, there is an increasing need to find ways to more wisely use the remaining, safest pesticides. This is particularly true for the many crop/disease combinations which do not represent large enough markets to pay for the cost of new compound registration. Wiser pesticide use will include ways to reduce application rates (and thus potential residues), finding ways to extend registrations to new crops, and identifying new compositions and treatments to combat the development of pest resistance.

The chemical pesticides are time and again known to have provided an effective method of control; however, the public has become concerned about the amount of residual chemicals which might be found in food, ground water and the environment. Stringent new restrictions on the use of chemicals and the elimination of some effective pesticides from the market place could limit economical and effective options for controlling pests. In addition, the regular use of chemical toxins to control unwanted organisms can select for resistant strains.

Alternative strategies to pesticide application are needed for the control of agriculturally important pests. Such strategies will help address public concern regarding pesticide pollution, as well as the perception that pesticide residues on food pose a threat to human health.

There has been widespread reporting to the effect that pests indeed are highly detrimental to humans. Pests include pathogenic organisms that infest mammals and plants, such as those that infest or feed upon plants and livestock, thus causing economic loss or diminishment of plant crops, plant products, and livestock. For example, the glassy-winged sharpshooter is a pest that feeds on grape vines, thus diminishing the crop available for wine production. Other pests may infest structures such as dwellings, residences, hospitals, and commercial establishments, such as restaurants and retail stores. These pests may be detrimental to the structure, such as termites feeding on wooden beams, or simply be a nuisance to people who visit or live in infested buildings. Additionally, some pests are vectors for certain diseases that harm humans and non-human animals, including pets and livestock.

The recent advancements in the field of scientific and technical research have shown that the transmission of vector-borne diseases through pests is a problem throughout the world and is best controlled through the control of those vectors. For example, the deer tick (Lxodes scapularis) may transmit Lyme disease to a host when feeding on the host's blood by passing an infectious microbe (Borrelia burgdorferi), which lives in the tick's midgut, into the host's bloodstream. A mosquito (Aedes aegypti), prevalent throughout many tropical and sub-tropical regions of the world, may transmit Dengue Fever, Yellow Fever, or encephalitis viruses to a host on which it feeds. The rat flea (Xenopsylla cheopis) is a vector for the microbe (Yersinia pestis) that causes the Plague.

Hence, in the present scenario the realization amongst the researchers is that though the pest control is often difficult to achieve yet it is the need of the hour. Many pesticides are toxic to humans and animals and may pollute the environment. Hence, a number of commonly used pesticides, such as organophosphates, have been restricted or made commercially unavailable. Biopesticides derived from natural sources, such as plants, fungi, or other natural products, offer a safer alternative to chemically synthesized pesticides. Biopesticides generally have fewer health effects and can be better for the environment, but many biopesticides offer substantially weaker control of pests, or control only a limited spectrum of pests, while other biopesticides may be environmentally toxic. For example, pyrethrins—pesticides made from the extract of the chrysanthemum plant—control a wide variety of pests, but are very toxic to fish, such as bluegill and lake trout. Additionally, pests may become resistant to certain compounds after continued use; for example, insect resistance to pyrethrins already has been observed. Thus, new pest control agents particularly those derive from natural sources and having an essentially biological origin offer an alternative for commonly used pesticides and connote the future in the realm of biocontrol.

With rapid emergence of the insect pest resistance to the commercially available chemical insecticides/pesticides, the biopesticides are gaining increasing importance for implementing the integrated pet management. Plants produce compounds that may pests or have the potential to alter their feeding behaviour, growth, development, molting process or may even be capable of disrupting their mating and oviposition so as to offer an option in terms of its utilization in the pest management programs.

At present there exist several approaches for developing biopesticide compositions and biopesticide formulations as well as the isolation, chemical elucidation and characterization of these biopesticide compositions of natural origin, in general and from Eucalyptus genus in particular. However, the isolation and characterization of biopesticide compositions and biopesticide formulations from Eucalyptus species, that are capable of conferring anti-pest activity to serve as effective biocontrol agent, is so far not reported and prior art profile does not indicate either the existence or use of these biopesticide compositions and biopesticide formulations for use in research and/or industry.

Thus the biopesticide compositions and biopesticide formulations from the Eucalyptus species, whether used in isolation or in combination with each other or in conjunction with ingredients and/or compounds/substances of both organic and inorganic origin, obtained in accordance with the present invention have the potential of exploitation in not only the field of biocontrol and effective pest control management but also in several diverse areas such as biomarkers, diagnostic tools and kits as well as biopesticides and/or bioinsecticides and also therapeutic formulations for human, plants and livestock usage.

The prior art profile indicates the existence of numerous biopesticide compositions and biopesticide formulations obtained from variety of sources, but biopesticide compositions and biopesticide formulations capable of serving as effective anti-pest and biocontrol agents of natural biological origin are the novel aspect of this invention, and the same are hitherto unknown.

The U.S. Pat. No. 7,018,641 issued in favor of Momol et al discloses an invention featuring materials and methods for controlling of plant pathogens. The invention further provides that essential oils that can be used for the control of plant pathogens. Advantageously, the subject invention provides fumigants that provide an alternative to methyl bromide and other pre-plant fumigants. According to the subject invention, in a preferred embodiment essential oils can be used to control bacterial and fungal soilborne diseases of vegetables, ornamental plants and other plants. Specifically exemplified herein are essential oils from the following plants: Palmarosa (Cymbopogon martini), tea tree (Melaleuca alternifolia), lemongrass (Cymbopogon flexuosus) and Eucalyptus citriodora. Additionally, thymol which is a fraction of thyme (Thymus vulgaris) oil was found effective to control plant diseases. In a specific embodiment of the subject invention, geraniol, which is a fraction of palmarosa, can be used to effectively control plant pathogens. Specifically, exemplified herein is the use of geraniol and/or palmarosa oil against the bacterial wilt pathogen. The essential oils of the subject invention and their derivatives are highly advantageous for pesticidal use because they occur commonly in nature, have little mammalian toxicity, are compatible with other biological control strategies and are readily broken down to innocuous components.

The U.S. Pat. No. 7,230,033 issued in favor of Dolan et al discloses an invention featuring compositions and methods for controlling an arthropod pest population that include an eremophilane sesquiterpene pest control agent (such as, nootkatone or 13-hydroxy-valencene) and a dialkyl-substituted phenol pest control agent (such as, carvacrol) are disclosed. The compounds present in the compositions may be isolated from natural sources, semi-synthesized from naturally occurring compounds, or completely synthesized. The pest control compositions may be applied directly to a pest or the locus of a pest, and function as topical or ingestible pest toxins.

The U.S. Pat. No. 6,372,211 issued in favor of Issac et al discloses an invention describing compositions and methods for controlling insects by co-expressing an amino acid oxidase and a second enzyme that provides insecticidal activity when present in a mixture with the amino acid oxidase are disclosed. Also disclosed are DNA and protein sequences, and transformed microorganisms and plants useful for achieving such insect control.

The U.S. Pat. No. 6,455,079 issued in favor of Khanuja et al describes a novel insecticidal composition comprising extract(s) obtained from the plant Albizzia lebbeck and .delta.-endotoxin from. Bacillus thuringiensis, useful in effectively controlling the lepidopteran crop damages insects. The invention also provides a process for the preparation of the said composition and a method for the application of the composition.

The U.S. Pat. No. 6,545,043 issued in favor of Coats et al describes a method for suppressing target pests, comprising exposing the pests to an effective biopesticidal amount of a composition, the composition comprising a carrier and a purified glucosinolate breakdown product having a hydroxyl group attached, wherein a starting material for the purified glucosinolate breakdown product is isolated from a crambe plant or mustard plant, further wherein the target pests could be, fungi, bacteria or root knot nematodes is disclosed. Methods for suppressing target pests without limitation as to the starting materials are also disclosed wherein the pests are exposed to an effective biopesticidal amount of a composition comprising a carrier and either an analog or a derivative of a purified glucosinolate breakdown product having a hydroxyl group attached.

The U.S. Pat. No. 6,231,865 issued in favor of Hsu et al pertains to a natural pesticide and describes a synergistic effect when garlic oil or extract is combined with essential oils which results in an improved insecticide/fungicide which is natural and contains no chemical additives. Essential oils are defined in this application to be volatile liquids obtained from plants and seeds including cotton seed oil, soybean oil, cinnamon oil, corn oil, cedar oil, castor oil, clove oil, geranium oil, lemongrass oil, linseed oil, mint oil, sesame oil, thyme oil, rosemary oil, anise oil basil oil, camphor oil, citronella oil, eucalyptus oil, fennel oil, ginger oil, grapefruit oil, lemon oil, mandarin oil, orange oil, pine needle oil, pepper oil, rose oil, tangerine oil, tea tree oil, tee seed oil, mineral oil and fish oil.

The U.S. Pat. No. 6,207,705 issued in favor of Coats et al describes novel biopesticides which can replace commercial pesticides and biopesticides which have been banned, restricted, or are being phased out, including, but not limited to chloropicrin, dichlorvos and methyl bromide. Many of the biopesticides of the present invention are excellent fumigants, possessing quick action and volatility, while posing less risk than currently used pesticides to humans and the environment. The biopesticides of the present invention are natural and closely-related synthetic derivatives or analogs related to two classes of natural compounds, namely glucosinolates and monoterpenoids.

The U.S. Pat. No. 6,133,196 issued in favor of Ocamb et al pertains to biological control of plant diseases and describe an invention in which conifer seeds or nascent seedlings are contacted with a composition comprising a mixture of two genera of microorganisms, namely, a biologically pure culture of an ectomycorrhizal fungus capable of colonizing the roots of a conifer, and a biologically pure culture of a bacterial control agent inhibitory to the growth of Fusarium spp. This composition may be applied to seeds prior to planting, or to young seedlings undergoing transplantation. The invention thus provides a method for reducing the incidence of Fusarium infection in conifer seedlings grown from conifer seeds. This is an important advance in the art since Fusarium infestations in nurseries can obliterate conifer stocks, and reduce the survival of more mature seedlings which must be thinned and transplanted. In an alternative method, conifer seeds are first coated with a culture of the bacterial biological control agent. The residue is allowed to dry to form a protective coating, and upon planting, the region of planting medium surrounding the seed is impregnated with a culture of the ectomycorrhizal fungus. A further embodiment involves first coating the seed with the biological control agent, and then later, after the seed has germinated seedling has emerged, further treating the nascent root with a culture of ectomycorrhizae upon transplantation, or adding it to the plant-growth medium in sufficient quantity to saturate the region surrounding the rhizosphere. Since the principal manifestations of Fusarium infection are the formation of root rot and damping off of plant stems, the methods of the invention result in reduction in the incidence of root rot and damping off.

The prior art indicated above does not provide a reference of biopesticide compositions and/or biopesticide formulations obtained from Eucalyptus species capable of serving as effective biocontrol agents and/or pest control management agents.

Accordingly there exists a need for providing a novel biopesticide compositions and biopesticide formulations for effective pest control and biocontrol management capable of controlling (e.g., repelling or exterminating) a variety of pests, inclusive of but not confined to insects, fungi, bacteria as well as the vectors of disease, which biopesticide compositions are relatively safe for humans, animals, plants, and the environment.

There also remains an emerging need for pest control methods and biocontrol methods, which are more compatible with the need for affordable and effective disease control, a high degree of food safety, and minimal environmental impact.

In view of the foregoing disadvantages inherent in the above-mentioned prior art, the general purpose of the present invention is:

to provide an improved combination of convenience and utility,
to include all the advantages of the prior art,
to attempt to overcome the major disadvantages/drawbacks of the prior art, and
to provide novel biopesticide compositions and biopesticide formulations capable of serving as effective anti-pest and biocontrol agents.

### SUMMARY OF INVENTION

The present invention provides new novel biopesticide compositions and biopesticide formulations capable of serving as effective anti-pest and biocontrol agents.

The present invention describes the isolation and characterization of the novel biopesticide compositions and/or biopesticide formulations obtained from Eucalyptus species capable of serving as effective biocontrol agents and/or pest control management agents.

The invention further describes the isolation, structure elucidation and evaluation of pesticidal, biological, biocontrol, ethno botanical, as well as therapeutic properties of these biopesticide compositions and/or biopesticide formulations obtained from Eucalyptus species capable of serving as effective biocontrol agents and/or pest control management agents.

It is an object of the present invention to provide a biopesticide compositions and/or biopesticide formulations capable of serving as effective biocontrol agent.

It is another objective of the present invention to provide a biopesticide compositions and/or biopesticide formulations capable of effectively acting against a variety of pests and vectors.

Another objective of the present invention is to provide novel biopesticide compositions and/or biopesticide formulations, which can also serve as biomarkers in, allied fields of investigation and research studies.

For a better understanding of the invention, its operating advantages and the specific objects attained by its user, reference should be made to the accompanying drawings and descriptive matter in which there are illustrated embodiments of the invention.

### BRIEF DESCRIPTION OF DRAWINGS

For a better understanding of the nature of the present invention, reference should be made to the detailed description taken in conjunction with the accompanying drawings in which:

FIG. 1 is a diagrammatic depiction of the simplified flow chart for isolation of biopesticide compositions.

FIG. 2 is a diagrammatic depiction of pesticidal effect of biopesticide compositions.

FIG. 3 is a block depiction of insecticidal effect of biopesticide compositions of the present invention.

### DETAILED DESCRIPTION OF INVENTION

The exemplary embodiments described herein detail for illustrative purposes are subject to numerous variations. It is understood that various omissions, substitutions or equivalents are contemplated as circumstances may suggest or render expedient, but is intended to cover the application or implementation without departing from the spirit or scope of the invention.

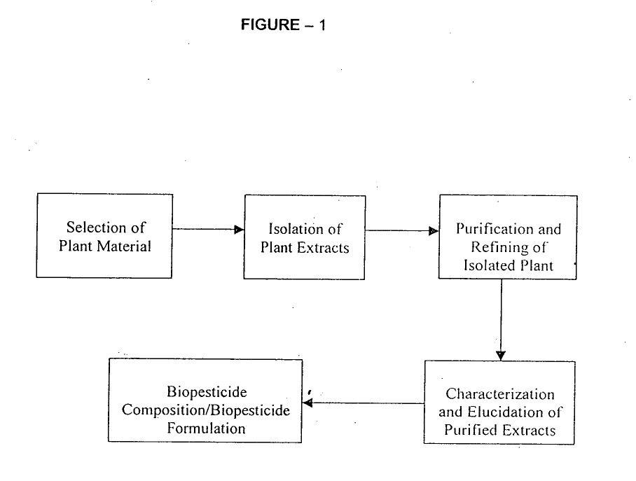

FIG. 1 is a diagrammatic depiction of the simplified flow chart for isolation of biopesticide compositions.

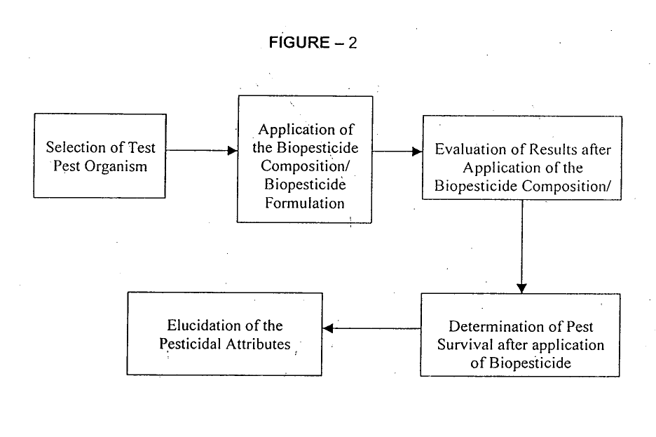

FIG. 2 is a diagrammatic depiction of pesticidal effect of biopesticide compositions of the present invention.

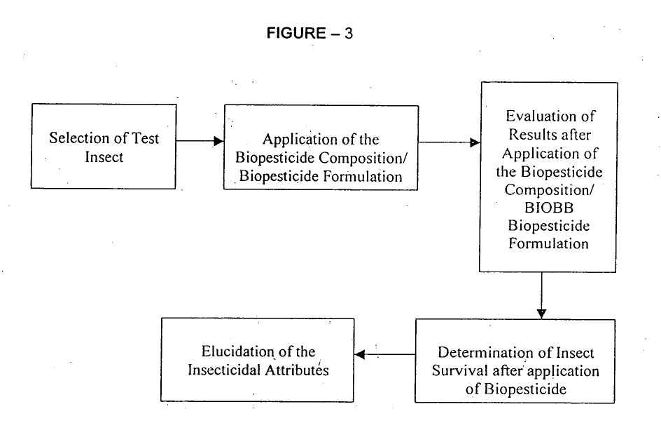

FIG. 3 is a block depiction of the insecticidal effect of biopesticide compositions of the present invention.

In the preferred embodiment of invention, the best working mode of the invention entails isolation of biopesticide compositions and/or biopesticide formulations obtained from Eucalyptus species capable of serving as effective biocontrol agents and/or pest control management agents.

### Example 1

### Selection of Plant Species

The common plants of family Myrtaceae generally include Eucalyptus camaldulensis, Syzygium aromaticum, S. cuminii, S. fruiticosum, S. jambos, S. malaccense, Psidium guajava, Pimento officinalis, Myrtus communis, Callistemon rigidus, Melaleuca communis, and M. leucadendron.

The literature survey revealed that the initial screening of the Eucalyptus spp. extract was found to work as insect growth regulator in controlling reproduction of rice brown hopper (Nilaparvata lugens) (Shanthi and Janarthan, 1995). It was found to be more repellent than Neem and Datura extract against rice moth (Cocyra cephalonica) (Devraj and Srilatha, 1993). E. globulus extract had larvicidal activity against Aedes aegypti and Culex quinquetasciatus (Monzon et al 1994). C. lanceolatus extract was found to be larvicidal and anti-ovipostion against C. quinquefasiatus (Mohsen et al. 1990). Syzygium aromaticum extract was found active against stored grain pest Tribolium castaneum (Ho et al. 1995).

Since the literature survey showed Eucalyptus, Callistemon and Syzygium as potential genera to be explored for their pesticidal properties also as they are widely cultivated in India, three plant species belonging to these genera were selected for studying their pesticidal properties.

### Example 2

### Selection of Insect Pest Species to Conduct Bioassays

The cotton bollworm (Helicoverpa armigera) is one of the most destructive pests of many crops in India as well as other geographical territories. It's survival is reported on nearly 181 host plant species (Reed and Pawar, 1982). It attacks many economically important crop species viz. cotton, pigeonpea, chickpea, tomato, sunflower, etc. Currently it is one of the most difficult species to control because of emergence of resistance to commercially available insecticides.

Being polyphagous in nature, its control becomes very important. Higher rates of resistance against commercial insecticides have been recorded in H. armigera from different parts of India. High levels of resistance to DDT in Helicoverpa armigera (Hubner) were recorded in larvae collected from chickpea and pigeonpea at International Crops Research Institute for the Semi-Arid Tropics (ICRISAT), Patancheru, A. P., between 1986-87.

As per a recorded report, in India, the poor control of H. armigera by synthetic pyrethroids was first recorded on pigeonpea at Guntur, A. P. in 1986. Poor control was not evident on cotton grown in that area, perhaps because of low populations during that year. Then in 1987, very poor control of H. armigera was recorded on a large scale in the major cotton growing areas of Andhra Pradesh. To tackle this situation, many farmers in this area used synthetic pyrethroids, endosulfan, organophosphate insecticides, and sometimes a mixture at 2-3 days intervals during the critical period. During that particular year, the farmers could not get effective control despite spraying their cotton crop 30 times during the season (compared to the 9-10 recommended sprays).

Of the total insecticides applied, the synthetic pyrethroids accounted for 50-70% applications. As a result of the poor control of H. armigera, the average cotton yields for the major cotton growing districts of Andhra Pradesh, Krishna, Guntur and Prakasam dropped from 436 kg ha-1 in 1986-87 to 168 kg ha-1 in 1987-88.

In the year 1989, high levels of resistance to cypermethrin were recorded in strains from cotton in the cotton growing regions of Guntur, A. P. and Coimbatore, Tamil Nadu and from pigeonpea near Hyderabad. In 1990-91, the survey indicated the pyrethroid resistant populations were present throughout much of Andhra Pradesh. Tolerance to quinalphos had increased slightly in 1990-91, while resistance to methomyl had increased substantially, particularly in the cotton growing area of Guntur. In the year 1997, H. armigera had devastated whole cotton crop in Andhra Pradesh. These facts reflect the seriousness of the Helicoverpa problem. Therefore, Helicoverpa armigera was selected as a pest species to test the pesticidal activity of these plant species.

### Example 3

### Collection of Leaf Material

The Leaf material of three-plant species viz. Eucalyptus camaldulensis, Syzygium cuminii and Callistemon rigidus belonging to family Myrtaceae were collected from an identified geographical domain for conducting bioassays and preparation of extracts. The leaves were shade dried and crushed into powder in a mixer grinder for bioassay studies and preparation of extracts. The trees were marked so that leaf material can be collected as and when required.

### Example 4

### Preparation of Insect Culture

The Helicoverpa armigera culture was reared on artificial diet as described by Singh and Rembold (1992) (Table 1). The part I and part II of the diet are weighed separately. Part III is prepared by melting agar in boiling water. Part I of the diet is mixed immediately into part III and the part II is mixed when the mixture cools down to 60-70° C. The contents are mixed vigorously and transferred into small perspex trays. After cooling, the diet is kept at 4° C. The diet was prepared routinely for the insect rearing. The culture was maintained in a BOD at 27+/−2° C., 70% RH and 10:14 LD photoperiod. The larvae were reared in individual Borosil glass tubes plugged with cotton plugs and were fed small amount of diet that was replaced if the diet becomes dehydrated.

The pupae formed were separated and transferred to clean jars provided with a piece of filter paper to facilitate moth emergence and were observed daily for adult emergence. After emerging of the moths, males and females were kept separately in glass jars and fed with 10% honey solution. The moths were paired in the mating cage (20×15 cm) made up of perspex on the 3rd day of emergence as suggested by Singh and Rembold (1988). The moths were provided with cotton swab dipped in 10% honey solution as food and these swab were recharged daily with fresh solution. The cage was provided with lining of cotton tissue paper. Cotton layers/tissue paper containing eggs were transferred to the glass jars that were provided with moist cotton swab for maintaining high humidity. Neonates were transferred onto the Chickpea diet flakes on the day of hatching initially in the plastic boxes, and after 3-4 days were transferred individually in the glass vials. Due precautions were taken during culture maintenance and laboratory population was supplemented with field collected larvae after 3-4 generations in order to meet the larval availability throughout the experimental period.

### Example 5

### Test Biological Activity

### Chronic Feeding Bioassay

The test material was mixed with the dry portion of the artificial diet. For bioassay experiments, 10 replications with 10 larvae per replications were taken. Ist instar larvae were released on treated diet. Each larva was reared individually in Borosil tubes plugged with cotton plugs. Larvae were reared on test diet from 1^{st} instar to pupation stage. Rate of survival (survival over time), development time (mean number of days needed to reach a given instar), moulting disorders, larval weight at 7^{th} day and pupal weight were recorded as performance variables. Tubes were inspected daily to replace food, record larval moulting and mortality, and to record on-set of pupation. Standard statistical analysis was performed to calculate the percent survival, development period and the relative growth of larvae.

For conducting the bioassays of the fractions diet coating bioassay method was standardized. Necessary modifications in the concentration of agar was made to facilitate the pouring of diet through microtitre. Amount of diet to be poured and amount of solution of the testing material, were standardized. Accordingly, 750 ^{u} of the normal diet was poured into Borosil glass vials (25×60/25×100 mm) with the help of repeater pipette. The diet was then coated with 200 ^{u} l of the test solution topically using pipetteman and allowed to dry. First instar larvae were released on this treated diet to observe the effect of the test solution on growth and survival. Alternatively, diet can be poured in a microtitre plate and then coated with the test solution.

### Contact Activity Bioassay

Direct contact toxicity of Eucalyptus and Callistemon formulations (10% EC) was determined by topical application method for third and fifth instar H. armigera larvae, whereas toxicity against second instar larvae was evaluated by spraying aqueous emulsions using Potter's tower.

For topical applications, the test formulations (water based) in 5 ^{u} l dose were applied to the dorsum of third and fifth instar H. armigera larvae using a fine micropipette. Treated larvae were reared on artificial diet and observations on mortality counts were recorded daily at 24 hrs interval up to 3 days. Moribund larvae were considered as dead. Data was subject to probit analysis (Finney, 1971) to determine the effective concentration (EC) values based on the calculated regression lines.

For spraying application, ten larvae were placed in each glass petri plate (5-cm radius Borosil) and were sprayed under Potter's tower with 1 ml of test material. Immediately after the treatment, the larvae were dried under room conditions and transferred on plastic petri dishes (2.5 cm radius) containing cabbage leaf disc (12.5 sq. cm), which were treated with the test formulations following leaf dip method for 5 seconds. Counts for recording mortality were taken 24 hrs after the treatment and the data was subjected to probit analysis.

After 24 hrs of treatment and mortality recordings, the alive larvae were transferred individually into the glass vials (25×100 mm, Borosil) where 50% larvae were provided with treated cabbage leaves (leaf dip for 5 seconds) while the other 50% were released on untreated cabbage leaves for each of the test concentration and the test formulation. Observations on the larval instars and further mortality, if any were recorded for another 7 days for each of the treatment. On the last day of treatment (7^{th} day), larval weights of the treated and untreated cabbage were recorded separately for each of the test concentrations to observe the growth inhibitory effect against H. armigera larvae.

### Feeding Inhibition Bioassay

Feeding inhibition action of Eucalyptus and Callistemon formulations (10% EC) was determined against pre-starved (4 hrs) fifth instar H. armigera larvae using okra fruit dip method both for choice and no-choice test conditions. Market purchased okra (Bhindi) fruits were dipped for 5 seconds and allowed to dry for 1 hour.

For no-choice test condition, one treated fruit was placed in each glass petri plate (5 cm radius, Borosil) and fifth instar larva was released individually for each of the treatment group. Under choice test, the surface area of the glass petri plate was divided into equal halves by glass pen marking for providing the dual feeding option. The treated and untreated fruits were placed on the left and right halves of the petri plate, respectively and fifth instar larvae were allowed to feed individually. For control treatment, aqueous emulsions of Blank (solvent system, 5.0%) were considered as treated control and water treated fruits as untreated or pure control.

Observations on the feeding consumption were recorded daily for 3 days at 24 hrs interval keeping 5 replicate for each treatment (n=5). For data recording, a six level (0-5) scale was designed and further converted into numerical points for data analysis.

The point data was then used for statistical analysis and subjected to Analysis Variance (ANOVA) in order to work out effective treatment for each of the formulation.

### Example 6

### Bioassays with Leaf Powder

The Preliminary bioassays were conducted using chronic feeding method by mixing the crude leaf powder in the insect diet were conducted separately with E. camaldulensis, S. cuminii and C. rigidus, in order to select a promising species. E. camaldulensis was found to be the most promising species. More than eighty percent growth inhibition with slow growth and development of larvae was observed with Eucalyptus treatment. None of the larvae could survive beyond third instar stage, resulting in hundred percent mortality. The larvae, which survived till 7^{th} day in second instar stage, were very small in size and could not convert into pupae. Developmental periods of first and second instar were prolonged to 10-15 day as against 2-3 days with normal diet.

In the case of C. rigidus ninety percent mortality was recorded. In the remaining ten percent population, highly deformed pupae and adults were recorded. Maximum mortality was observed during transition from second instar to third instar. Larval periods were prolonged as compared to control. S. cuminii was found to have no effect on growth, survival and development of H. armigera.

The experiment was repeated two times in order to confirm the results. Further bioefficacy experiments were conducted with different levels of E. camaldulensis and C. rigidus leaf powder (2% and 1%) in the artificial diet to check whether the effect was dose dependent or not. Slow growth and development of the larvae was observed at both the levels with E. camaldulensis leaves with distinct effect of concentration levels. The larvae could not survive beyond L3 stage at 2% level of Eucalyptus leaf powder while in case of Callistemon at 2% level the percent survival was 20% at pre-pupal stage with only 10% survival till adult formation having high degree of deformity. Developmental period and growth were also found to be affected up to 2% level.

Based on the results of the preliminary bioassays E. camaldulensis and C. rigidus have shown to be promising species whereas S. cuminii proved ineffective. Therefore, further studies were taken up with E. camaldulensis and C. rigidus.

### Example 7

### Preparation of Crude Extracts and their Bioassays

The extracts were obtained with E. camaldulensis and C. rigidus, from their leaf powder in n-Hexane, ethanol and acetone in soxhlet apparatus. The solvents were evaporated in the rotary vacuum evaporator and the dried extracts were kept at 4° C. for conducting bioassay studies. Essential oil from the leaves of E. camaldulensis and C. rigidus sps was also extracted by steam distillation method using clevenger apparatus, for conducting bioassays. The water extracts remaining after oil extraction were also concentrated for conducting bioassays.

The semi-synthetic diets having 5% of the extracts/oils were prepared to perform the bioassay. First instar larvae were released and observations were taken to assess the insect behavior on these diets. Polar extracts exhibited more activity than the non-polar extracts. Ethanol extract was found to be having maximum activity at 5% test level among ethanol, hexane, acetone, water and oil extracts having 90% of growth inhibition. Second highest activity was recorded in acetone extract followed by water extract. The slow growth resulted in high mortality in ethanol and acetone extracts. However, non-polar extracts viz. hexane and oils showed very poor activity and growth inhibition level of 50% with essential oil and 60% with hexane extract. Further bioassays were conducted using lower concentrations of the ethanol extracts of Eucalyptus and Callistemon to determine the ED₅₀ values. For Eucalyptus alcohol extract ED₅₀ was found to be 0.3% whereas with Callistemon it was 1.2%. These concentrations of activity with crude extract are very promising. The photographic representation of the growth inhibiting effect of various extracts of Eucalyptus and Callistemon on Helicoverpa armigera was also recorded.

### Example 8

### Fractionation of the Extracts and Bioassays of the Fractions

The fractionation of the crude ethanol extracts of the Eucalyptus and Callistemon was done by two approaches. In one approach partitioning with solvents having variable polarity was done and in another approach fractionation on silica gel column chromatography using different solvents and solvent mixtures as eluant was carried out. The fractions were monitored through thin layer chromatography. Similar fractions were pooled together and subjected to bioassay. Based on the bioassay results active fractions were identified.

### Example 9

### Extraction and Fractionation Methodology

The developed and standardized protocol isolation, purification and characterization of the extracts are being enumerated and described below.

### Preparation of Crude Extracts

The powdered material (50 g) was packed into a thimble made of Whatman filter paper No. 1 and extracted with 500 ml of polar solvent using Soxhlet extraction apparatus for 48 h until the solvent extracted no more colour. The extract was concentrated under reduced pressure using rotary-vacuum evaporator to yield the crude extract. The viscous solution of extract was obtained from rotary-vacuum evaporator.

### Fractionation of the Crude Extracts

The concentrated polar/ethanol extracts of Eucalyptus was fractionated through partitioning with combination of solvents of varying polarities. In addition to this, ethanol/polar extract also subjected to column chromatography.

The steps followed for fractionation the extract are reported below. The crude extract (10 g) was dissolved in ethyl acetate (250 ml×4). The ethyl acetate extracts were combined and concentrated using rotary-vacuum evaporator to yield dark brown-green powder (II a). Ethyl acetate water insoluble (II b) was rejected. This powder was re-dissolved in 500 ml of 70% acetone (aqueous) and subjected to filtration. Insoluble green solid powder was obtained on filtration (II c). The left over red-brown water filtrate (II d) on acetone evaporation was divided into two equal parts (75 ml each). The first red-brown water filtrate (75 ml) was subjected to extraction with n-butanol (250 ml×3) separating n-butanol and water layer. The n-butanol soluble extracts were combined and concentrated in vacuum using rotary evaporator producing brown viscous semi solid (II e). Sodium bisulphite (1.5 g) as suggested for the extraction of high purity tannins (Anonymous, 1952) was added to the second water fraction (75 ml) and kept overnight. Sediments were removed by centrifugation at 10,000 rpm for 5 min as brown solid (II f). Hydrolysis of the remaining reddish brown water fraction was done with 2N HCl, placed in a water bath at 80° C. and neutralised with 30% aqueous Na2CO3 solution (w/v). After neutralisation, 3 g of sodium bisulphite was added again and kept overnight. Sedimentation was collected by centrifugation as reddish-violet crystals (II g).

Tannins were also extracted directly from leaf powder using traditional method (Foo and Porter, 1980). Leaf powder (50 g) was subjected to 70% aqueous acetone (500 ml) in a Soxhlet apparatus for 48 h. The 70% aqueous acetone soluble was filtered and subjected to rotary vacuum evaporator for solvent evaporation. The left over water fraction was extracted with n-butanol (500 ml×3) in a separatory funnel. The n-butanol-extracts were combined and concentrated in vacuum using rotary evaporator. This led to the production of brown solid powder termed as crude tannins (IV).

### Extraction of Tannins by WHO Recommended Procedure

The leaves of Eucalyptus were shade dried and ground to fine powder in a mixer grinder. The known amount (25 g) of powdered material was taken into a conical flask to which 150 ml water was added. The mixture was allowed to heat over a boiling water bath for 30 min. After heating and subsequent cooling, the mixture was transferred to a 250 ml volumetric flask and dilute to volume with water. The mixture was allowed to settle. The liquid was filtered through a filter paper, discarding the first 50 ml of the filtrate.

Out of this filtrate, 50 ml of the water-soluble extract was concentrated using rotary evaporator followed by water bath drying. The residue was dried in an oven at 105° C. for 4 h and weighed accurately (T1). Out of the remaining filtrate, 80 ml of the plant material extract was taken in a separate conical flask to which 6 g of hide powder was added. The mixture was allowed to shake for 60 min. The liquid was then filtered. Following this, 50 ml of the clear filtrate was taken to dryness. The residue was dried in an oven at 105° C. for 4 h and weighed accurately (T2).

Consequent upon this, 6 g of hide powder was taken in a separate conical flask, added 80 ml of water and allowed to shake for 60 min. The mixture was filtered and 50 ml of the filtrate was taken to dryness as per the method described above. The dried residue was weighed accurately (T0).

### Confirmation of Tannins

The tannins thus produced i.e. brown solid powder (II f) and reddish-violet crystals (II g), the n-butanol layer (IV) and as per WHO recommended procedure were subjected to standard tests for further confirmation based on some of their chemical reactions as suggested by Mukherjee (2002). Accordingly, the following colour reactions were performed taking tannic acid as a standard for tannin class of compounds.

(1.) Ferric chloride test: A small quantity of ferric chloride (5 mg) when added to an aqueous solution of the tannins (0.1 g in 10 ml water) produced a bluish green colouration following reaction.

(2.) Precipitation by alkaloids: A small quantity of alkaloids (extracted from T. indica) when added to an aqueous solution (0.1 g in 10 ml) of tannins, a pale-white precipitate was produced after 3 h, which was not dissolved on shaking

(3.) Precipitation by heavy metals: A small quantity of lead acetate (5 mg) when added to en aqueous solution of the tannins (0.1 g in 10 ml water) produced a pale-yellow precipitate following reaction.

The yield of tannins obtained with different procedures were compared for efficiency of extraction procedures.

### Column Chromatography

Crude ethanol extract was subjected to column chromatography to identify active fraction other than the tannins. Column preparation and loading The essential part of the apparatus consisted of a long narrow glass tube (100 cm long and 3.5 cm diameter) with a capacity to hold 200 g column packing material. Activated silica gel (60-120 mesh) was used as packing material for this purpose. Activation was done by heating the silica gel in an oven at 120° C. for 60 min. Slurry of the silica gel was prepared in hexane solvent for introducing the mixture on to the column. The slurry was poured through the funnel into a clean dry column clamped vertically and adsorbent was allowed to settle evenly for 48 h. In order to obtain uniform packing, gentle tapping of the column was done with a wooden rod. Solvent was allowed to elute and more slurry was added until required length of the column was obtained. Fresh solvent was allowed to flow through the column under the hydrostatic pressure to remove air bubbles, if any, and to avoid the formation of cracks and channels as this may lead to distortion of adsorption bands. Freshly prepared 20 g crude ethanol extract evaporated to dryness under reduced pressure was re-dissolved in 25 ml of ethanol Solvent adding column adsorbent equal to 3 times its weight (60 g silica gel). The extract solution adsorbed evenly on the silica gel and allowed the solvent to evaporate completely. The adsorbent loaded with crude extract was then added to the column top and packed into an even layer. After introduction of the extract on to the column, initial adsorption took place rapidly and hence considered ready for chromatogram development.

### Elution of the Column

The ethanol crude extract was chromatographed on silica gel (60-120 mesh). Column elution was carried out with increasing polarity of hexane and ethanol solvent mixture in the ratio of 100:0, 90:10, 80:20, 70:30, 60:40, 50:50, 40:60, 30:70, 20:80, 10:90, 0:100 respectively. In total eleven solvent mixtures were used. One hundred ten fractions (each 45 ml) were collected during the complete chromatogram development. These fractions were then grouped in t0 28 fractions based on the TLC pattern and then screened individually for their growth inhibition action against H. armigera larvae by diet incorporation method. These fractions were concentrated under reduced pressure in rotary-vacuum evaporator. The weight of each fraction was recorded.

Fractions thus obtained were further fractionated by using successive medium pressure liquid chromatography (MPLC) on silica gel to get pure compounds The combination of high field 2D NMR spectroscopy experiments and mass spectrometery were used for structural characterization

In another preferred embodiment of the present invention it is visualized to use the biopesticide composition/biopesticide formulation of the present invention to synthesize an effective biocontrol agent consisting of a mixture of the biopesticide composition/biopesticide formulation of present invention used in conjunction with insecticides such as Spinosad, Novaluron, Indoxacarb, Thiomethoxam, Acetamiprid, Imidocloprid, Chlorpyriphos, Avermectin (vertimec).

In yet another preferred embodiment of the present invention it is conceptualized to use the biopesticide composition/biopesticide formulation of the present invention to synthesize an effective biocontrol agent consisting of a mixture of the biopesticide composition/biopesticide formulation of present invention used in conjunction with fungicides such as Carbendazim, Mancozeb, Ridomil, Dithane M-45, Chlorothalanil and Propaconazole.

In still another preferred embodiment of the present invention it is conceptualized to use the biopesticide composition/biopesticide formulation of the present invention to synthesize an effective biocontrol agent consisting of a mixture of the biopesticide composition/biopesticide formulation of present invention used in conjunction with microbe derived biopesticides such as Bacillus thuringiensis-Kurstakii based larvicide/insecticide, Beauveria bassiana based insecticide, Metarhizium anisoplae based insecticide Verticillium lecanii based insecticide, Paceliomyce based nematicide HaNPV based insecticide, Spodoptera Nucleopolyhedrovirus insect pathogen, Pseudomonas fluorescens based fungicide, Tricoderma viridae based fungicide and Trichoderma harzianum based fungicide.

In still another preferred embodiment of the present invention it is conceptualized to use the biopesticide composition/biopesticide formulation of the present invention to synthesize an effective biocontrol agent consisting of a mixture of the biopesticide composition/biopesticide formulation of present invention used in conjunction with at least one member of a pesticide assemblage that includes 2,4-dichlorophenoxy acetic acid, acephate, acetamiprid, alachlor, allethrin, alphacypermethrin, alphanaphthyl acetic acid, aluminium phosphide, anilophos, atrazine, aureofungin, azadirachtin (neem products), azoxystrobin, bacillus thuringiensis (b.t.), bacillus thuringiensis (b.s.), barium carbonate, beauveria bassiana, bendiocarb, benfuracarb, benomyl, bensulfuron, beta cyfluthrin, bifenazate, bifenthrin, bitertanol, bromadiolone, buprofezin, butachlor, captan, carbaryl, carbendazim, carbofuran, carbosulfan, carboxin, carfentazone ethyl, carpropamid, cartap hydrochloride, chlorofenvinphos, chlorfenapyr, chlorimuron ethyl, chlormequat chloride (ccc), chlorothalonil, chlorpyriphos, chlorpyriphos methyl, cinmethylene, clodinafop-propargyl (pyroxofop-propargyl), clomazone chlothianidin, copper hydroxide, copper oxychloride, copper sulphate, coumachlor, coumatetralyl, cuprous oxide, cyfluthrin, cyhalofop-butyl, cymoxanil, cypermethrin, cyphenothrin, dazomet, deltamethrin (decamethrin), diazinon, dichloro diphenyl trichloroethane (ddt), dichloropropene and dichloropropane mixture (dd mixture), diclorvos (ddvp), diclofop-methyl, dicofol, difenocenazole, difenthiuron, diflubenzuron, dimethoate, dimethomorph, dinocap, dithianon, diuron, dodine, d-trans allethrin, edifenphos, emamectin benzoate, endosulfan, ethephon, ethion, ethofenprox (etofenprox), ethoxysulfuron, ethylene dibromide and carbon tetrachloride mixture (edct mixture 3:1), fenamidone, fenarimol, fenazaquin, fenitrothion, fenobucarb (bpmc), fenoxaprop-p-ethyl, fenpropathrin, fenpyroximate, fenthion, fenvalerate, fipronil, flubendiamide, fluchloralin, flufenacet, flufenoxuron, flufenzine, flusilazole, fluvalinate, forchlorfenuron, fosetyl-al, gibberellic acid, glufosinate ammonium, glyphosate, hexaconazole, hexazinone, hexythiazox, hydrogen cyanamid, imazethapyr, imidacloprid, imiprothrin, indoxacarb, iprobenfos (kitazin), iprodione, isoprothiolane, isoproturon, kasugamycin, lambdacyhalothrin, lime sulphur, lindane, linuron, lufenuron, magnesium phosphide plates, malathion, mancozeb, mepiquate chloride, mesosulfuron methyl+iodosulfuron methyl sodium, metalaxyl, metalaxyl-m, metaldehyde, methabenzthiazuron, methomyl, methoxy ethyl mercury chloride (memc), methyl bromide, methyl chlorophenoxy acetic acid (mcpa), methyl parathion, metiram, metolachlor, metribuzin, metsulfuron methyl, milbemectin, monocrotophos, myclobutanil, novaluron, nuclear polyhyderosis virus of helicoverpa armigera, nuclear polyhyderosis virus of spodoptera litura, oxadiargyl, oxadiazon, oxycarboxin, oxydemeton-methyl, oxyfluorfen, paclobutrazole, paraquat dichloride, penconazole, pencycuron, pendimethalin, permethrin, phenthoate, phorate, phosalone, phosphamidon, prallethrin, pretilachlor, primiphos-methyl, profenophos, propanil, propergite, propetamphos, propiconazole, propineb, propoxur, pyrachlostrobin, pyrethrins (pyrethrum), pyridalyl, pyriproxyfen, pyrithiobac sodium, quinalphos, quizalofop ethyl, quizalofop-p-tefuryl, s-bioallethrin, sirmate, sodium cyanide, spinosad, streptomycin+tetracycline, sulfosulfuron, sulphur, tebuconazole, temephos, thiacloprid, thifluzamide, thiobencarb (benthiocarb), thiodicarb, thiomethoxain, thiometon, thiophanate-methyl, thiram, transfluthrin, triacontanol, triadimefon, triallate, triazophos, trichlorofon, trichoderma viride, tricyclazole, tridemorph, trifluralin, validamycin, verticillium lecanii, zinc phosphide, zineb and ziram.

Likewise, it is also contemplated to use the biopesticide composition/biopesticide formulation of the present invention to develop and synthesize an effective biocontrol agent consisting of a mixture of the biopesticide composition/biopesticide formulation of present invention to be used in conjunction with other known active ingredients, and the invention is intended to embrace and anticipate all such conceptualized variants.

Although, a particular exemplary embodiment of the invention has been disclosed in detail for illustrative purposes, it will be recognized to those skilled in the art that numerous variations or modifications of the disclosed invention, including the rearrangement in the molecular configuration of the biopesticide compositions and/or biopesticide formulations of the present invention as well as its method of use being amenable to modifications on account of an application in diverse fields such as biocontrol, effective pest control and pest control management, therapeutic and/or diagnostic tools as well as biopesticide formulation based biomarkers are possible.

Accordingly, the invention is intended to embrace all such alterations, modifications and variations as may fall within the spirit and scope of the present invention.

I/We claim:

1. A novel biopesticide composition/biopesticide formulation isolated from plant parts/plant part based extracts belonging to a plant group comprising selected Eucalyptus plants.

2. The biopesticide composition/biopesticide formulation of claim 1, wherein said selected Eucalyptus plants are inclusive of Eucalyptus camaldulensis.

3. The biopesticide composition/biopesticide formulation of claim 1, wherein said selected Eucalyptus plants are inclusive of Eucalyptus globus, Eucalyptus citrodora, Eucalyptus terraticornis, Eucalyptus hybrid, Eucalyptus globulus, Eucalyptus gummifera, Eucalyptus marginta, Eucalyptus regnans, Eucalyptus oblique, Eucalyptus calophyla, Eucalyptus sideroxylon, Eucalyptus leucoxylon, Eucalyptus dives, Eucalyptus macarthuri and Eucalyptus maculate citrodion.

4. The biopesticide composition/biopesticide formulation of claim 1, wherein said composition is possessing pesticidal attributes.

5. The biopesticide composition/biopesticide formulation of claim 1, wherein said composition is possessing biocontrol attributes.

6. The biopesticide composition/biopesticide formulation of claim 4, wherein said pesticidal attributes are effective against target groups selected from fungi, bacteria, nematodes, insects and vectors.

7. A novel biopesticide composition/biopesticide formulation isolated from plant parts/plant part based extracts belonging to a plant group comprising a combination of selected Eucalyptus plants and at least one member from selected plant consortium.

8. The biopesticide composition/biopesticide formulation of claim 7, wherein said selected plant consortium is inclusive of Acacia, Aleurites, Alphitonia, Alyxia Anogeissus, Arbutus, Arctostaphylos, Betula, Bixa, Caesalpinia, Castanea, Coriaria, Cornus, Callistemon, Dillenia, Diospyros, Elaeagnus, Ephedra, Euphorbia, Eurya acuminata DC, Fragaria, Geranium and Heimia.

9. The biopesticide composition/biopesticide formulation of claim 7, wherein said selected plant composition is further inclusive of Juglans, Lagerstroemia, Lemaireocereus, Liquidambar, Lycopus europeus L, Lythrum salicaria L, Menyanthes, Nuytsia, Oenothera, Phyllanthus, Platanus, Polygonum, Psidium, Psophocarpus, Punica, Quercus, Ricinus, Rubus, Neem, Rotenae, Tylophora, Cymopogone, Aspergillus, VAM fungi, Chaetomium and Solanum.

10. The biopesticide composition/biopesticide formulation of claim 7, wherein said selected Eucalyptus plants are inclusive of Eucalyptus camaldulensis.

11. The biopesticide composition/biopesticide formulation of claim 7, wherein said selected Eucalyptus plants are inclusive of Eucalyptus globus.

12. The biopesticide composition/biopesticide formulation of claims 7 or 8 or 9, wherein said composition is possessing pesticidal attributes.

13. The biopesticide composition/biopesticide formulation of claims 7 or 8 or 9, wherein said composition is possessing biocontrol attributes.

14. The biopesticide composition/biopesticide formulation of claim 12, wherein said pesticidal attributes are effective against target groups selected from fungi, bacteria, insects, nematodes and vectors.

15. The biopesticide composition/biopesticide formulation of claim 1, wherein said composition is possessing insecticidal attributes.

16. The biopesticide composition/biopesticide formulation of claim 7 or 8 or 9, wherein said composition is possessing insecticidal attributes.

17. A biocontrol composition comprising a mixture of the biopesticide composition/biopesticide formulation of claim 1 used in conjunction with insecticides such as Spinosad, Novaluron, Indoxacarb, Thiomethoxam, Acetamiprid, Imidocloprid, Chlorpyriphos, Avermectin (vertimec).

18. A biocontrol composition comprising a mixture of the biopesticide composition/biopesticide formulation of claim 1 used in conjunction with nematicides such as Dazomet and Paceliomyce based nematicide.

19. A biocontrol composition comprising a mixture of the biopesticide composition/biopesticide formulation of claim 1 used in conjunction with fungicides such as Carbendazim, Mancozeb, Ridomil, Dithane M-45, Chlorothalanil and Propaconazole.

20. A biocontrol composition comprising a mixture of the biopesticide composition/biopesticide formulation of claim 1 used in conjunction with microbe derived biopesticides such as Bacillus thuringiensis-Kurstakii based larvicide/insecticide, Beauveria bassiana based insecticide, Metarhizium anisoplae based insecticide, Verticillium lecanii based insecticide, Paceliomyce based nematicide, HaNPV based insecticide, Spodoptera Nucleopolyhedrovirus insect pathogen, Pseudomonas fluorescens based fungicide, Trichoderma viride based fungicide and Trichoderma harzianum based fungicide.

21. The biopesticide composition of claim 1, wherein said plant extract from which said biopesticide composition is isolated, is further inclusive of tannins, polyphenolic compounds, phloroglucinol compounds, eucalyptus oil containing terpene compounds, and triterpeniod compounds.

22. The biopesticide composition of claim 21, wherein said polyphenolic compounds are further inclusive of gallic acid and ellagic acid.

23. The biopesticide composition of claim 21, wherein said phloroglucinol compounds could be in the form of formylated phloroglucinol compounds.

24. The biopesticide composition of claim 23, wherein said formylated phloroglucinol compounds are further, inclusive of,
(a). Euglobal assemblage;
(b). Macrocarpal assemblage;
(c). Eucalyptone assemblage;
(d). Sideroxylonal assemblage;
(e). Grandinal assemblage;
(f). Jensenal assemblage;
and,
(g). Eucalyptin assemblage.

25. The biopesticide composition of claim 24, wherein said Euglobal assemblage is further inclusive of euglobal I A 1, euglobal-IB, euglobal-IC, euglobal-IIA, euglobal-IIB, euglobal-IIC, euglobal-III, euglobal-IVB, euglobal-VII, and euglobal-IA2.

26. The biopesticide composition of claim 24, wherein said Macrocarpal assemblage is further inclusive, of Macrocarpal A, Macrocarpal B, Macrocarpal C, Macrocarpal D, Macrocarpal E, Macrocarpal F, and Macrocarpal G.

27. The biopesticide composition of claim 21, wherein said ‘eucalayptus oil containing terpene compounds’ are further inclusive of 1,8-cineole, terpineol acetate, aromandendrene, globulol and sesquiterpene alcohol.

28. The biopesticide composition of claim 21, wherein said triterpeniod compounds are further inclusive of ursolic acid lactone, betulinic acid, oleanolic acid and triterpenoid amirinic acid.

29. A biocontrol composition comprising a mixture of the biopesticide composition/biopesticide formulation of claim 1 used in conjunction with any neem based insecticide.

30. The biopesticide composition of claim 1, wherein said plant extract from which said biopesticide composition is isolated, is further inclusive of 1,8-cineole, 11,12-dehydroursolactone-acetate, 3-isopropyliden-1-acetyl-5-cyclopentene, 3-omethylellagic-acid-4′ rhamnoside, allo-aromadendrine, alpha-aromadendrene, alpha-eudesmol plant, alpha-phellandrene, alpha-pinene, aromadendrene, beta-diketone, beta-eudesmol, beta-pinene, butyraldehyde, caffeic-acid, camphene, caproaldehyde, carvone, chlorogenic-acid, citriodorol, cuminaldehyde, d-catechol, d-linalol, d-myrtenal, d-myrtenol, d-verbenone, ellagic-acid, epiglobulol and eucalyptin.

31. The biopesticide composition of claim 1, wherein said plant extract from which said biopesticide composition is isolated, is further inclusive of ferulic-acid, gallic-acid, gamma-terpinene, gentisic-acid, globulol, i-terpineol, isoamyl-alcohol, ledol, p-cymene, paraffin, pinene, pinocarveol, pinocarvone, protocatechuic-acid, quercetin, quercetol, quercetol-3-glucoside, quercetrin, quercitrin, rutin, trans-pinocarveol, tritriacontane-16,18-dione, valeraldehyde and viridiflorol.

32. The biopesticide composition/biopesticide formulation of claim 5, wherein said biocontrol attributes are effective against a host of test insects.

33. The biopesticide composition/biopesticide formulation of claim 32, wherein said test insects are inclusive of Sitophilus oryzae, Sitophilus granarius, Acanthoscelides obtectus, Corcyra cephalonica, Callasobruchus chinensis, Tribolium confusum, Rhyzopertha dominica, Phthorimaea opercullela, Callasobruchus maculatus, Tribolium castaneum, Ephestia kuehniella, Trialeurodes aporariorum, Thaumetopoea pityocampa, Henosepilachna vigintioctopunctata, Nilparvata lugens, Tyrophagous putrescentiae, arrora jacobsani, Tecia solanivora, Aproaerema modicella, Scirtothrips dorsalis, Myzus persicae, Coptotermes formosanus, Helicoverpa armigera, Anopheles spp., Culicoides imicola, Culicoides sonorensis, Anophele gambiae, Anophele darlingi and Culex pipiens pallens.

34. A biocontrol composition of claim 17, wherein said composition is equipped to be effective against a host of test insects.

35. The biocontrol composition of claim 34, wherein said test insects are inclusive of Sitophilus oryzae, Sitophilus granarius, Acanthoscelides obtectus, Corcyra cephalonica, Callasobruchus chinensis, Tribolium confusum, Rhyzopertha dominica, Phthorimaea opercullela, Callasobruchus maculatus, Tribolium castaneum, Ephestia kuehniella, Trialeurodes aporariorum, Thaumetopoea pityocampa, Henosepilachna vigintioctopunctata, Nilparvata lugens, Tyrophagous putrescentiae, arrora jacobsani, Tecia solanivora, Aproaerema modicella, Scirtothrips dorsalis, Myzus persicae, Coptotermes formosanus, Helicoverpa armigera, Anopheles spp., Culicoides imicola, Culicoides sonorensis, Anophele gambiae, Anophele darlingi and Culex pipiens pallens.

36. The biopesticide composition/biopesticide formulation of claim 4, wherein said target groups against which said pesticidal attributes are effective, are inclusive of bollworm complex, spodeptera complex, Platella xylostella, while fly, jassids and mealy bugs.

37. The biopesticide composition/biopesticide formulation of claim 36, wherein said bollworm complex further includes Helicoverpa, Pectinophora and Earias.

38. A biocontrol composition comprising a mixture of mixture of the biopesticide composition/biopesticide formulation of claim 1 used in conjunction with selected vegetable oils.

39. The biocontrol composition of claim 38, wherein said vegetable oils could include linseed, mustard, castor and jatropha oil.

40. A biocontrol composition comprising a mixture of mixture of the biopesticide composition/biopesticide formulation of claim 1 used in conjunction with a pesticide assemblage derived from a selected source.

41. The biocontrol composition of claim 40, wherein said selected source could be inclusive of chemical as well as biological type origin.

42. The biocontrol composition of claim 40, wherein said pesticide assemblage is inclusive of:
2,4-dichlorophenoxy acetic acid, acephate, acetamiprid, alachlor, allethrin, alphacypermethrin, alphanaphthyl acetic acid, aluminium phosphide, anilophos, atrazine, aureofungin, azadirachtin (neem products), azoxystrobin, bacillus thuringiensis (b.t.), bacillus thuringiensis (b.s.), barium carbonate, beauveria bassiana, bendiocarb, benfuracarb, benomyl, bensulfuron, beta cyfluthrin, bifenazate, bifenthrin, bitertanol, bromadiolone, buprofezin, butachlor, captan, carbaryl, carbendazim, carbofuran, carbosulfan, carboxin, carfentazone ethyl, carpropamid, cartap hydrochloride, chlorofenvinphos, chlorfenapyr, chlorimuron ethyl, chlormequat chloride (ccc), chlorothalonil, chlorpyriphos, chlorpyriphos methyl, cinmethylene, clodinafop-propargyl (pyroxofop-propargyl), clomazone, chiothianidin, copper hydroxide, copper oxychloride, copper sulphate, coumachlor, coumatetralyl, cuprous oxide, cyfluthrin, cyhalofop-butyl, cymoxanil, cypermethrin, cyphenothrin, dazomet, deltamethrin (decamethrin), diazinon, dichloro diphenyl trichloroethane (ddt), dichloropropene and dichloropropane mixture (dd mixture), diclorvos (ddvp), diclofop-methyl, dicofol, difenocenazole, difenthiuron, diflubenzuron, dimethoate, dimethomorph, dinocap, dithianon, diuron, dodine, d-trans allethrin, edifenphos, emamectin benzoate, endosulfan, ethephon, ethion, ethofenprox (etofenprox), ethoxysulfuron, ethylene dibromide and carbon tetrachloride mixture (edct mixture 3:1), fenamidone, fenarimol, fenazaquin, fenitrothion, fenobucarb (bpmc), fenoxaprop-p-ethyl, fenpropathrin, fenpyroximate, fenthion, fenvalerate, fipronil, flubendiamide, fluchioralin, flufenacet, flufenoxuron, flufenzine, flusilazole, fluvalinate, forchlorfenuron, fosetyl-al, gibberellic acid, glufosinate ammonium, glyphosate, hexaconazole, hexazinone, hexythiazox, hydrogen cyanamid, imazethapyr, imidacloprid, imiprothrin, indoxacarb, iprobenfos (kitazin), iprodione, isoprothiolane, isoproturon, kasugamycin, lambdacyhalothrin, lime sulphur, lindane, linuron, lufenuron, magnesium phosphide plates, malathion, mancozeb, mepiquate chloride, mesosulfuron methyl+iodosulfuron methyl sodium, metalaxyl, metalaxyl-m, metaldehyde, methabenzthiazuron, methomyl, methoxy ethyl mercury chloride (memc), methyl bromide, methyl chlorophenoxy acetic acid (mcpa), methyl parathion, metiram, metolachlor, metribuzin, metsulfuron methyl, milbemectin, monocrotophos, myclobutanil, novaluron, nuclear polyhyderosis virus of helicoverpa armigera, nuclear polyhyderosis virus of spodoptera litura, oxadiargyl, oxadiazon, oxycarboxin, oxydemeton-methyl, oxyfluorfen, paclobutrazole, paraquat dichloride, penconazole, pencycuron, pendimethalin, permethrin, phenthoate, phorate, phosalone, phosphamidon, prallethrin, pretilachlor, primiphos-methyl, profenophos, propanil, propergite, propetamphos, propiconazole, propineb, propoxur, pyrachlostrobin, pyrethrins (pyrethrum), pyridalyl, pyriproxyfen, pyrithiobac sodium, quinalphos, quizalofop ethyl, quizalofop-p-tefuryl, s-bioallethrin, sirmate, sodium cyanide, spinosad, streptomycin+tetracycline, sulfosulfuron, sulphur, tebuconazole, temephos, thiacloprid, thifluzamide, thiobencarb (benthiocarb), thiodicarb, thiomethoxain, thiometon, thiophanate-methyl, thiram, transfluthrin, triacontanol, triadimefon, triallate, triazophos, trichlorofon, trichoderma viride, tricyclazole, tridemorph, trifluralin, validamycin, verticillium lecanii phosphide, zineb and ziram.

43. A biocontrol composition comprising a mixture of mixture of the biopesticide composition/biopesticide formulation of claim 1 used in conjunction with at least one member from an active ingredient assemblage derived from a selected source.

44. The biocontrol composition of claim 43, wherein said selected source could be inclusive of chemical as well as biological type origin.

45. The biocontrol composition of claim 43, wherein said active ingredient assemblage is inclusive of:
acetic acid, agrobacterium radiobacter, allium sativum (garlic), allyl isothiocyanate (mustard, oil of), alternaria destruens, aminoethoxyvinylglycine hydrochloride, ammonium bicarbonate, ammonium nonanoate, ampelomyces quisqualis, anagrapha falcifera nucleopolyhedrosis virus (npv), anise oil, anthraquinone, aspergillus flavus, azadirachtin, bacillus cereus, bacillus licheniformis, bacillus mycoides isolate, bacillus popilliae spores, bacillus pumilus, bacillus sphaericus, bacillus subtilis, bacillus subtilis var. amyloliquefaciens, bacillus thuringiensis subsp. aizawai delta-endotoxin in killed pseudomonas fluorescens, bacillus thuringiensis var. aizawai (plasmid insert php12537), bacillus thuringiensis subsp. israelensis, bacillus thuringiensis subsp. kurstaki, kurstaki delta-endotoxin in killed pseudomonas fluorescens, bacillus thuringiensis subsp. kurstaki, bacillus thuringiensis subsp. san diego delta-endotoxin in killed pseudomonas fluorescens bacillus thuringiensis subsp. tenebrionis, balsam fir oil, bacteriophages of pseudomonas syringae pv. tomato, beauveria bassiana, bergamot oil, black pepper oil, burkholderia cepacia, candida oleophila isolate, canola, castor oil, catmint oil, cedarwood oil, chenopodium ambrosioides, chenopodium quinoa, saponins, chitin, chitosan, chondrostereum purpureum, chondrostereum purpureum, cinnamaldehyde, cis-7,8-epoxy-2-methyloctadecane, citronella oil, citronellol, colletotrichum gloeosporioides f.sp. aeschynomene, coniothyrium minitans, corn gluten meal, coyote urine, cuelure (4-[p-acetoxyphenyl]-2-butanone), cydia pomonella granulosis virus (gv), cyclohexanecarboxylic acid, cytokinin, decanoic acid monoester with 1,2-propanediol, decanoic acid monoester with glycerol, diallyl sulfides, dodecanoic acid monoester with 1,2-propanediol, dodecanoic acid monoester with glycerol, dipotassium phosphate, douglas fir tussock moth, dried blood, and dyer's woad rust (puccinia thlaspeos strain woad).

46. the biocontrol composition of claim 43, wherein said active ingredient is further inclusive of:
ethyl (2e,4e,7s)-trimethyl-2,4-dodecadienoate, ethylene, eucalyptus oil eugenol, fatty acid monoesters with glycerol or propanediol, fish oil, formic acid, gamma aminobutyric acid (gaba), geraniol, gibberellic acid, gibberellic acid, monopotassium salt, gibberellin a4 mixed with gibberellin a7, gliocladium catenulatum, gliocladium virens g-21, glycerol monocaprate, glycerol monocaprylate, glycerol monolaurate, ground sesame stalks, gypsy moth npv, harpin ab protein, harpin protein, helicoverpa zea npv (previously heliothis zea npv), hydrogen peroxide, Indian meal moth, granulovirus (plodia interpunctella gv), indole, indole-3-butyric acid, ionone, alpha, iron phosphate (ferric phosphate), isopropyl (2e,4e)-11-methoxy-3,7,11-trimethyl-2-4 dodecadienoate (methoprene), isopropyl (2e,4e,7s)-11methoxy-3,7,11-trimethyl-2-4 dodecadienoate, jojoba oil, kaolin, kinetin (n-(2-furanylmethyl)-1-h-purin-6-amine).

47. The biocontrol composition of claim 43, wherein said active ingredient is further inclusive of:
ethyl (2e,4e,7s)-trimethyl-2,4-dodecadienoate, ethylene, eucalyptus oil eugenol, fatty acid monoesters with glycerol or propanediol, fish oil, formic add, gamma aminobutyric acid (gaba), geraniol, gibberellic acid, gibberellic acid, monopotassium salt, gibberellin a4 mixed with gibberellin a7, gliocladium catenulatum, gliocladium virens g-21, glycerol monocaprate, glycerol monocaprylate, glycerol monolaurate, ground sesame stalks, gypsy moth npv, harpin ab protein, harpin protein, helicoverpa zea npv (previously heliothis zea npv), hydrogen peroxide, indian meal moth, granulovirus (plodia interpunctella gv), indole, indole-3-butyric acid, ionone, alpha, iron phosphate (ferric phosphate), isopropyl (2e,4e)-11-methoxy-3,7,11-trimethyl-2-4 dodecadienoate (methoprene), isopropyl (2e,4e,7s)-11-methoxy-3,7,11-trimethyl-2-4 dodecadienoate, jojoba oil, kaolin, kinetin (n-(2-furanylmethyl)-1-h-purin-6-amine).

48. The biocontrol composition of claim 43, wherein said active ingredient is further inclusive of:
l-glutamic acid, lagenidium giganteum, lauryl alcohol, lavandin oil, lemon grass oil, linalool, lysophosphatidylethanolamine (Ipe), mamestra configurata npv, maple lactone, meat meal, metarhizium anisopliae esf1, metarhizium anisopliae, methoprene, methyl anthranilate; methyl eugenol (me), methylcyclopropene (mcp), methyl salicylate, mint oil, modified cry 3a bt corn, mono & di-potassium salts of phosphorous acid, muscodor albus qst, mustard oil, myristyl alcohol, myrothecium verrucaria, dried fermentation solids & solubles, neem oil, clarified hydrophobic nitrogen liquid, nosema locustae, n6-benzyladenine, octanoic acid monoester with 1,2-propanediol, octanoic acid monoester with glycerol, octenol, orange oil, oxypurinol.

49. the biocontrol composition of claim 43, wherein said active ingredient is further inclusive of:
p-menthane-3,8-diol, pantoea agglomerans, pantoea agglomerans, paecilomyces fumosoroseus, paecilomyces lilacinus, pelargonic acid, phosphorous acid and it's ammonium, sodium, and potassium salts, phytophthora palmivora, piperine, plant extract, plant oils, polyoxin d zinc salt, potassium bicarbonate, potassium dihydrogen phosphate, potassium silicate, potato leafroll virus (plrv) replicase protein as produced in potato plants, propylene glycol monocaprate, propylene glycol monocaprylate, propylene glycol monolaurate, pseudomonas chlororaphis, pseudomonas aureofaciens, pseudomonas fluorescens, pseudomonas syringae, pseudomonas syringae pv. tomato, pseudozyma flocculosa, puccinia thlaspeos strain woad (dyer's woad rust), putrescent whole egg solids, pythium oligandrum, red pepper, reynoutria sachalinensis, rhamnolipid biosurfactant.

50. The biocontrol composition of claim 43, wherein said active ingredient is further inclusive of:
s-hydroprene, s-kinoprene, s-methoprene, saponins of chenopodium quinoa, sesame stalks, silver nitrate, sodium 5-nitroguaiacolate, sodium bicarbonate, sodium carbonate peroxyhydrate, sodium lauryl sulfate, sodium o-nitrophenolate, sodium p-nitrophenolate, sorbitol octanoate, soybean oil, sucrose octanoate esters, spodoptera exigua, streptomyces griseoviridis, streptomyces lydicus, thyme (herb), thymol (5-methyl-2-isopropyl-1-phenol), trichoderma harzianum, trichoderma polysporum, trypsin modulating oostatic factor, verbenone, verticillium isolate, xanthine, xanthomonas campestris pv. vesicatoria, yeast extract hydrolysate, zucchini yellow mosaic virus—weak strain pv. vesicatoria.

51. A method for obtaining novel biopesticide composition/biopesticide formulation from plant parts belonging to a group inclusive of Eucalyptus species, said method comprising steps of:
(a). Isolating a crude extract from plant parts;
(b). Refining said crude extract obtained from the Step (a);
(c). Characterizing said refined extract from the Step (b);
and,
(d). Carrying out the structural elucidation of said characterized extract from the Step (c).
